(19) United States
(12) Patent Application Publication
(10) Pub. No.: US 2007/0162307 A1
(43) Pub. Date: Jul. 12, 2007

(54) TOOLBAR USER INTERFACE FOR INFORMATION SYSTEM

(76) Inventors: Gary M. AUSTIN, Marietta, GA (US); James D. Peters, Alpharetta, GA (US)

Correspondence Address: MCGUIREWOODS, LLP, 1750 TYSONS BLVD, SUITE 1800, MCLEAN, VA, 22102, US

(21) Appl. No.: 11/622,443

(22) Filed: Jan. 11, 2007

Related U.S. Application Data
(60) Provisional application No. 60/758,325, filed on Jan. 11, 2006.
(60) Provisional application No. 60/758,395, filed on Jan. 11, 2006.
(60) Provisional application No. 60/758,433, filed on Jan. 11, 2006.
(60) Provisional application No. 60/758,283, filed on Jan. 11, 2006.

(51) Int. Cl. G06Q 10/00; G06Q 40/00; G06F 3/048

(52) U.S. Cl. 705/2; 705/4; 715/779

(57) ABSTRACT

A method of operating an interoperable healthcare information system using a user interface of a computer system connected to the healthcare information system via a network is disclosed. Member identification information is received from a user via the user interface. The member identification information is sent to the healthcare information system. One of the healthcare programs is allowed to be selected for the member via the user interface. The information on the selected healthcare program is sent to the healthcare information system. The healthcare information system is searched to determine member's eligibility for the selected healthcare program based on the member identification information. The information on the member's eligibility for the selected healthcare program is displayed via the user interface.

### CROSS REFERENCE TO RELATED APPLICATIONS

This application claims the benefit of U.S. Provisional Patent Application No. 60/758,325, U.S. Provisional Patent Application No. 60/758,395, U.S. Provisional Patent Application No. 60/758,433 and U.S. Provisional Patent Application No. 60/758,283, each of which were filed on Jan. 11, 2006, and are incorporated by reference herein, in their entirety. Further, this application is related to U.S. patent application Ser. No. ______, entitled “SYSTEM AND METHOD FOR A SECURE PROCESS TO PERFORM DISTRIBUTED TRANSACTIONS,” U.S. patent application Ser. No. ______, entitled “SYSTEM AND METHODS FOR PERFORMING DISTRIBUTED TRANSACTIONS,” and U.S. patent application Ser. No. ______, entitled “SYSTEM AND METHODS FOR PERFORMING DISTRIBUTED PAYMENT TRANSACTIONS,” each of which are being filed simultaneously herewith, and are incorporated by reference herein, in their entirety. The invention is directed to a user interface system for accessing a healthcare information system.

### BACKGROUND OF THE INVENTION

1. Field of Invention

This invention relates generally to extending business interoperability to business entities, and, more particularly, to a system and process for efficiently extending interoperability for communications and data related to transactions to business entities in an overall business sector, such as healthcare.

2. Related Art

Generally, the issues facing the healthcare industry include the continuing need for efficiency in each of the industry market verticals (“Vertical (s)”) such as clinics, hospitals, insurance payers, etc. and (b) the lack of effectiveness for transactions that occur across these vertical segments, affecting the entire healthcare market sector (“Sector”, or “Horizontal”.) The ability to effectively conduct business electronically, across and between these Verticals in the entire healthcare Sector is referred to as interoperability. Whereas solutions from various companies exist that attempt to make the Verticals more efficient, there is no solution in the marketplace that makes the overall market sector effective. Generally, efficiently means to do things right; effectively means to do the right things.

Looking into each of the two issues identified above we note:

(a) Regarding the Vertical market segments, many companies have and continue to invest their resources and energies in making the Verticals more efficient through automation. This process is by no means complete, but the various market competitors continue to improve their products to deliver higher process efficiencies in each of these market segments. Examples of such companies are NextGen, GE Healthcare, Greenway Technologies, eClinicalWorks, Allscripts and others who have developed and market software solutions that increase the efficiency of clinics and medical offices. Similarly, corporations such as CERNER, SMS, McKesson and others have developed and market solutions that make hospitals more efficient. Others have done the same for other industry Verticals that contribute to the healthcare process, such as the insurance segment, the banking segment, the pharmacy segment, etc.

The lack of efficiency in the Vertical segments has been reviewed by the Institute of Medicine in the Untied States. On Mar. 1, 2001, the Institute of Medicine issued a report entitled Crossing the Chasm: A New Health System for the 21st Century that clearly describes the state of the healthcare industry in the United States. Specifically, this report states that the healthcare industry is in dire need of automation in all its operations, including hospitals, clinics and doctors in their practices (“Healthcare Providers”). This lack of automation causes healthcare to be expensive and inefficient, and it impedes the ability of healthcare providers to share electronically patient data, clinical and payment information. Such inefficiencies result not only in lost earnings (for example, it is estimated that in many cases as much as thirty percent (30%) of insurance claims are not paid because they cannot be processed due to improper coding), but also in exposure to potential legal liability that causes related insurance premiums to remain very high.

Furthermore, a federal statute governing the use of healthcare information, the Health Insurance Portability and Accountability Act of 1996, known as HIPAA, imposes federal requirements that affect healthcare providers and other covered entities. The regulations implementing HIPAA mandate certain changes that all healthcare providers must effect in their operations.

(b) The present lack of interoperability can be illustrated by the following quote from independent and credible third-party. The Health and Human Services (HHS) Secretary in 2006 said: “The U.S. health care system needs an interoperable electronic health records and billing system . . . I've come to conclude there really isn't a health care system. There's a health care sector . . . There's really nothing that connects it together into an economic system.”

Regarding the effectiveness of conducting business across the overall Sector, we note that there are numerous “Stakeholders” in the Healthcare Sector, including: Patients; Hospitals (including Urgent Care); Primary Physicians; Specialist Physicians; Pharmacies; Insurance Payers; Laboratories (for various tests, imaging, pulmonary, cardio, etc.); Pharmaceutical Companies; Banks that handle transaction payments including HSA/FSA accounts; Clearing Houses that negotiate a discounted network of services; Employers who participate in the payment of insurance premiums; Government that regulates and insures; and Associations that act as volume purchasing groups, such as Independent Physician Associations and Unions. Generally, a “Stakeholder” may be an individual, or corporation or other type of business who derives a business or personal benefit of any kind, and/or who contributes or participates in the delivery of healthcare services.

Whereas many companies are working hard to make each of these Stakeholders efficient (Verticals), there is no other solution in the marketplace that make the Horizontal processes effective (that is to say across the entire Healthcare Sector), at this time, nor is there a common infrastructure over which these stakeholders can conduct business effectively, in an automated way. In fact, it has been estimated that over 90% of some 30 billion healthcare transactions per year in the USA are paper based.

Moreover, there is a general mistrust among the key stakeholders, which is more or less natural in a market that is fraught with errors, fraud, inefficiency and shrinking margins. For example, in 2006, the head of the U.S. Department of Health and Human Services (HHS) has stated that in his estimate, that up to 25% of all Medicare transactions may be fraudulent.

This conflict is one of the main reasons why the various Stakeholders in healthcare do not collaborate, and hence the result is a disjointed, semi-automated and expensive healthcare delivery system, as illustrated in FIG. 1, where some of the Stakeholders are shown as pieces of a disjointed puzzle. I.e., there is no common infrastructure among Stakeholders. Furthermore, because collaboration is important but not mandatory for effectiveness, it is difficult for anyone of the major players to play a leading role, due to objections by their competitors. For example, if a first large insurance company would take an initiative to resolve some of the key industry problems, why would a second insurance company collaborate and risk losing market share? The answer is likely they would not. It becomes obvious that the marketplace would favor an independent party, especially one that offers advantages to each of the healthcare stakeholders.

It should be noted that parts of the effectiveness solution are being addressed by initiatives that are typically sponsored by various States of the Union and referred to as Regional Health Information Organizations (“RHIO”), such RHIOs are generally concerned with and attempt to provide a standard with which to electronically share medical records with care providers, such as hospitals, clinics and physicians. In this RHIO environment, the participating Stakeholders are limited to healthcare providing entities, and the type of information they share is limited to medical records. But, this fails to address the needs of all types of Stakeholders, in all of the various products and services they require, including medical records. Examples of the additional products and services addressed by this invention include but are not limited to: Records and benefits individuals (and their families) derive from their membership in Associations; employment data, including detailed healthcare benefits; records and access to banking products of the individuals for healthcare related accounts, such as Health Savings Accounts and other financial matters, such as records for healthcare tax exemptions; records of medications individuals have been prescribed for and other related issues, such as whether they have purchased their medication, etc.

Accordingly, there is a need for management of data and processes to effect the completion and recording of business transactions related to healthcare and a easy computer program with which remote and near users can enroll in such an information system, enter data, obtain offerings, and generally interface with and transact business such as healthcare related business.

### SUMMARY OF THE INVENTION

The invention meets the foregoing need and provides management of data and processes to effect the completion and recording of business transactions related to healthcare and a easy computer program with which remote and near users can enroll such an information system, enter data, and offerings and generally interface with and transact healthcare related business, which results in a significant improvement and other advantages apparent from the discussion herein.

Accordingly, in one aspect of the invention a method for operating a healthcare information system using a user interface of a computer system connected to the healthcare information system via a network is disclosed. Member identification information is received from a user via the user interface. The member identification information is sent to the healthcare information system. One of the healthcare programs is allowed to be selected for the member via the user interface. The information on the selected healthcare program is sent to the healthcare information system. The healthcare information system is searched to determine the member's eligibility for the selected healthcare program based on the member's identification information. The information on the member's eligibility for the selected healthcare program is displayed via the user interface.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows an information system structure constructed according to the principles of the invention;

FIGS. 2A, 2B, 2C, 2D and 2E show a toolbar for accessing the information system shown in FIG. 1 in various modes;

FIG. 3 shows an interaction chart among a member, provider and member service server via the toolbar of FIGS. 2A, 2B, 2C, 2D and 2E;

FIG. 4A shows a flow chart for a registration process constructed according to the principles of the invention;

FIG. 4B shows a flow chart for a security process constructed according to the principles of the invention; and

FIG. 5 shows a system architecture for the information system constructed according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

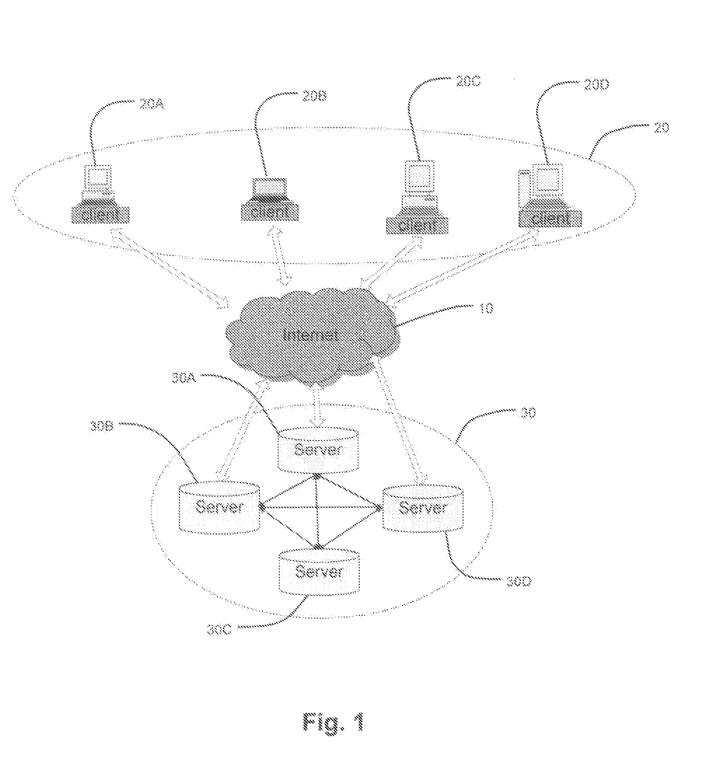

The invention is directed to a user interface system implemented to computer systems. As a particular example, the computer system is shown in the healthcare environment. Other environment may be used. As shown, the system which is part of a healthcare information system (hereafter “HIS”), such as one shown in FIG. 1. Generally speaking, the HIS includes a network 10, a health information exchange system 30 (hereafter “HIES”), and clients 20 implemented with the user interface system to access the health information exchange system through the network 10. The network may be the Internet 10 as shown in FIG. 1, or direct telecommunications lines, such as virtual private networks (VPN) or the like. The clients 20 may be various types of computers 20A, 20B, 20C and 20D, such as servers, laptops, desktop computers, PDAs, or the like, running on various operating systems, such as Microsoft™, Linux™, MacOS™ and the like. The user interface system may be a software program, which may be easily downloaded from the health information exchange system 30. The health information exchange system may be a collective pool of data provided by servers 30A, 30B, 30C, 30D operated by various health-related entities.

In an embodiment of the invention, the user interface is a multifunctional, transaction and interoperability, middleware toolbar for connecting, integrating, and communicating with the HIES. Once it is downloaded to a computer, the toolbar may be used for its own independent functionality. The functionality of the toolbar may be individually customized for each user, location, and/or user role. The toolbar may provide custom forms and form-fill capabilities, custom form processes and custom form responses.

The toolbar may provide connectivity to any software application on any computer on which it is downloaded. The toolbar may provide connectivity through the Internet from the computer where it is downloaded to other disparate entities, systems or software applications. The toolbar may display and interact with remote websites within the toolbar user interface.

The toolbar may integrate with software applications installed on computers on which it is downloaded. The toolbar may integrate with devices connected to the computer to which it is downloaded via software configurable adapters. The toolbar may distribute and install software driver and firmware updates to the computer to which it is installed and to any attached devices. The toolbar may be utilized to monitor the computer or devices connected to the computer to determine its location, configuration, connectivity and functionality on a continuous real-time basis.

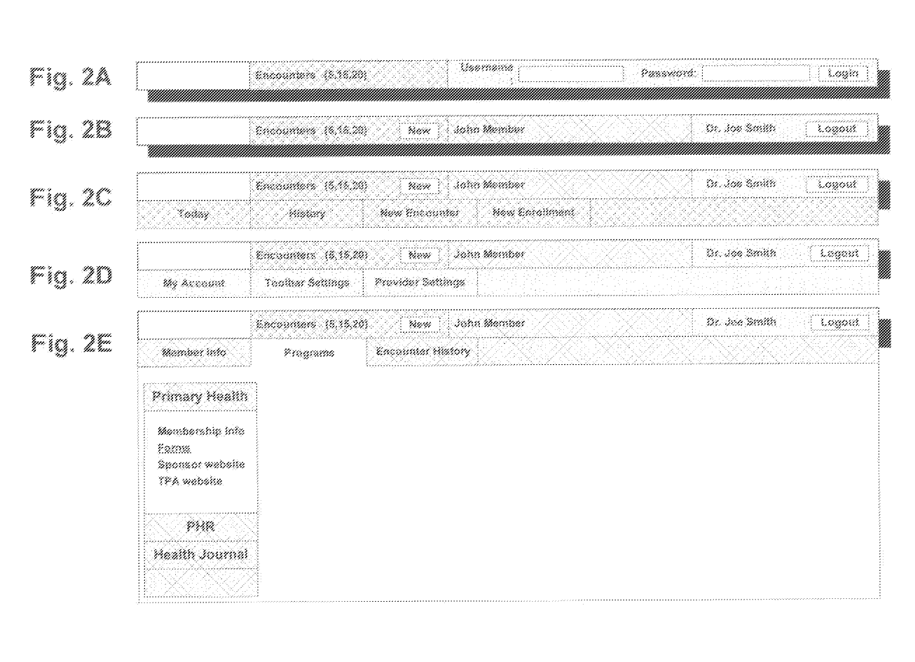

The toolbar, working in conjunction with the HIES, may provide integration and interoperability among all software applications that are integrated with the toolbar. The toolbar has the capability of enhancing existing software applications with any of the independent features and functionality of the toolbar and/or any other software applications or devices integrated with the toolbar. FIGS. 2A, 2B, 2C, 2D and 2E show the toolbar user interface (hereafter “toolbar”) in various states.

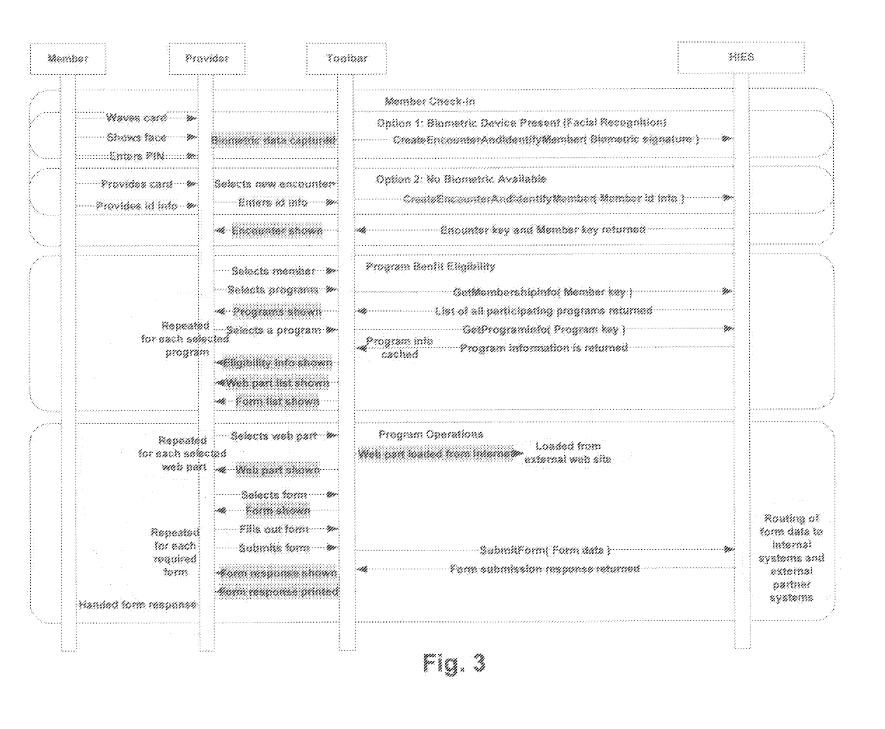

FIG. 3 shows an example of how the toolbar may be utilized among a member, provider and HIS. Healthcare providers such as hospitals or doctors' offices download the toolbar to their computers which is then integrated with their Practice Management System software (“PMS”) and/or Electronic Medical Records software (“EMR”) the toolbar also connects them to the HIS. When the toolbar is downloaded it captures a provider ID, it creates a device ID from the ID numbers of the internal components, and captures the IP address bank for that location. This information may indicate that the doctor is in fact a licensed healthcare provider, communicating on a registered computer from a registered IP address location. The toolbar may issue a provider authorization number to start a patient visit. The toolbar also integrates with a card reader and camera at the check in desk for positive patient ID and fraud control purposes. The device IDs are captured by the toolbar for every device used in the patient encounter process comes part of patient encounter transaction.

For example, when a patient checks in with the healthcare administrator at the healthcare provider's office prior to seeing the doctor, their healthcare benefit card is read by the card reader to capture the patient (hereafter “member”) ID number. The card reader communicates the ID number to the toolbar, which is connected to the HIS where all of the patient's employee benefit data is stored. By querying the HIS, the toolbar tells us who the card belongs to and if they are currently eligible for healthcare benefits at this time, or not. The toolbar then may look for the 3D facial recognition record stored on the HIS. When the record is found, the toolbar then activates the 3D camera at the administrator check-in desk, takes the patient's picture and compares it to the stored image on the HIS. If the images match, we now know that the person checking in is the owner and authorized user of the healthcare benefit card and eligible for health benefits. The toolbar then authorizes this event by issuing a transaction ID number. The toolbar initiates another automation at this point by sending the healthcare benefit card ID number, the provider's universal physician ID number and authorization number, all of the device IDs, and the transaction ID to the HIS. At this point the HIS has all of the information it needs to transmit the patient's Personal Health Record (PHR) to the provider. The toolbar then downloads a copy of the patient's PHR from the HIS, imports it into the provider's EMR and checks the patient in on the provider's PMS software. Now the patient is ready to see the provider. This extensive and complex sequence of processes was handled exclusively by the toolbar's automation capabilities. This is just one example of the toolbar's automation capabilities.

During the patient encounter, the provider can use the toolbar to download the patient's health risk assessment from the HIS and import it into the provider's EMR. When the provider has diagnosed the patient's problem they can utilize either the toolbar or the HIES to determine if the care and/or procedures they are recommending to treat the patient are covered expenses under the patient's healthcare benefit plan, or not. This is done by matching the procedure codes with covered expenses stated in the healthcare benefit plan's explanation of benefits (EOB). The toolbar can also give the provider the insurance payor's requirements for substantiating the necessity of the medical procedure that would justify payment by the payor. The toolbar can also query the EOB to determine the maximum allowable benefit payable by the payor to the provider for each medical procedure substantiated during the patient encounter. If the medical procedures are covered expenses under the EOB and have been properly substantiated and priced, the toolbar can submit the charges to the payer for payment. The tool bar can also be used for debiting and crediting payments. The toolbar can be utilized to send patient records from the provider's office to the hospital, to another provider, or to receive patient records from a hospital or another provider. The toolbar can even be utilized to process transactions and to debit and credit payments.

Additionally, the toolbar can access and display a library of custom forms that may be utilized to facilitate patient care and administer employee benefits. The toolbar may be utilized to replace Practice Management Software Electronic Medical Record software and Employee Benefit/Human Resources Management software. Employees can interact with their employer, their healthcare provider, their pharmacy, their insurance company, their personal health record (PHR) etc. with the toolbar.

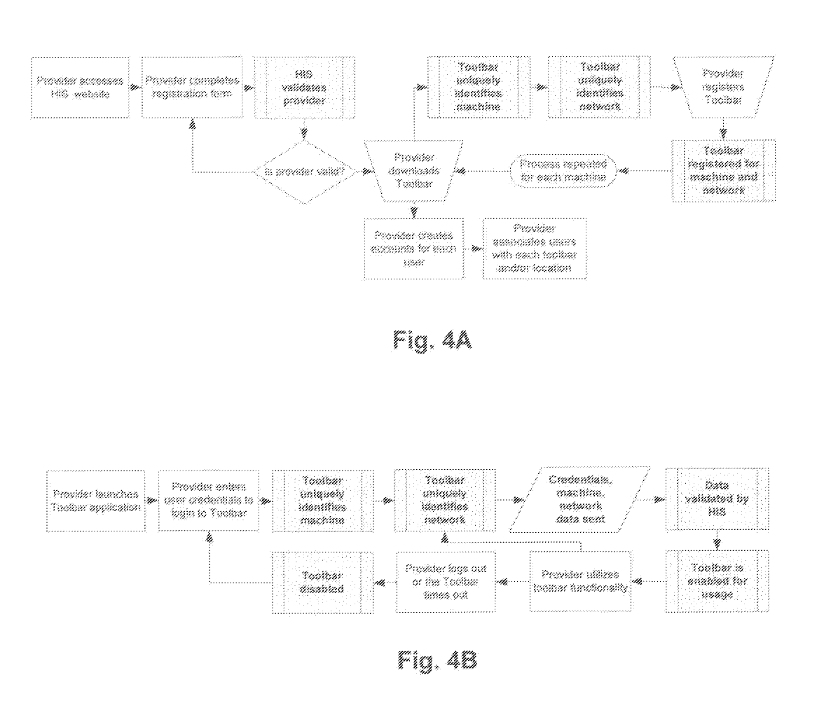

FIG. 4A shows a flow chart of a toolbar registration process constructed according to the principles of the invention. If the operator wishes to access the HIS, the user may be required to visit the HIS's website where he or she can complete an online registration form. The HIS reviews the registration form and validates the operator. However, the HIS may not validate the operator if there is a problem with the online registration form. Once the operator is validated, the HIS allows the operator to download the toolbar to his or her computer. During the installation, the toolbar may identify the computer and the network the computer is connected to. Once the toolbar is installed, the operator is requested to register the toolbar to the HIS. Then the registered toolbar may send information on the identified computer and network to the HIS. These steps may be repeated several times if the operator needs to install the toolbar in several computers. The operator is then required to create accounts for the users in each computer and associate the toolbar to the users.

FIG. 4b shows a flow chart of a security ensuring process. When the operator launches the toolbar, the operator is required to enter his or her login information to the toolbar. Then, the toolbar identifies the computer and the network the computer is connected to. The login information and information on the identified computer and network are sent to the healthcare information service to see if any of the provided information is different from the previously registered information. If there is no change, the toolbar is enabled for normal usage. However, if there is any change, the toolbar may be disabled for security reasons. Also, the toolbar may be disabled when the operator logs out of the toolbar.

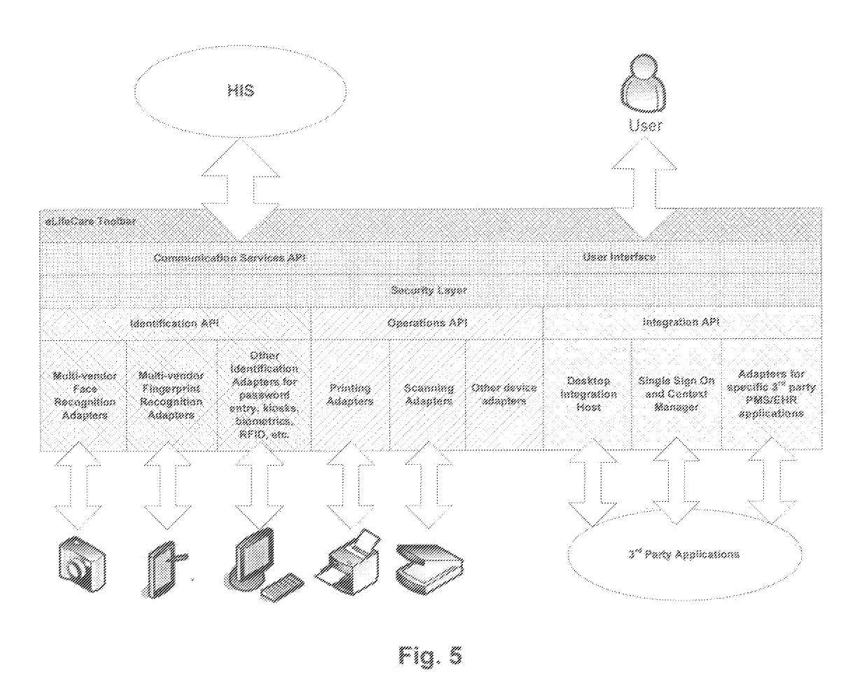

FIG. 5 shows the toolbar user interface architecture layers constructed according to the principles of the invention. At the highest level, the toolbar interfaces with the HIS and operator. At the second highest level, the interface with the HIS is assigned to communication services API, and the interface with the operator is assigned to the user interface. A security layer is provided at the third highest layer to support the communication service API and the user interface. At the fourth highest layer, identification API, operation API and integration API may be located. The identification API performs the member identification process, as mentioned above, and may be equipped with at least one of face recognition adapters, fingerprint recognition adapters and other identification adapters. Each adapter may be connected to an external identification devices such as the biometric device mentioned above. The operation API may include a printer adapter, scanner adapter or other adapters such that the operator may print information from the user via a printer connected to computer or a scanned image may be recognized by the toolbar. The integration API includes a desktop integration host and other features that allow the toolbar to be integrated with third party applications.

According to the invention, the HIS can be updated remotely via the Internet by one, many, or all users. The HIS automates access and interfaces between applications and/or devices to execute one or more secure processes. The processes can be initiated with or without user intervention. The HIS may include management tools that are displayed as “dials” on an electronic “Dashboard” specific to healthcare management, with green, yellow and red areas that denote the condition of the item indicated, along with a capability to drill down into specific elements that cause management concern.

The toolbar may monitor processes and log events. The toolbar may assign a unique ID number or use an ID number generated by the HIES to each event for tracking and other purposes. Also, the toolbar facilitates the sequencing and numbering of multiple events using secure processes to carry out secure transactions. Thus, the toolbar can help reduce fraud by integrating positive biometric personal identification into standard business process.

As explained so far, the toolbar can be utilized in the healthcare industry to help solve some of its biggest problems to do with accurate and biometrically verified identification of patients, thus making it very difficult for theft-of-service and eliminating most (but not all) opportunities for fraud. The toolbar working in conjunction with the health information service may be utilized to develop solutions to transform the healthcare industry by improving the business processes by connecting all of the stakeholders and the healthcare continuum including but not limited to employers, patients, healthcare providers, insurance payers, pharmacies, claims processors, claims translators, billing and collection companies, banks etc.

Also, employers and healthcare providers may use the toolbar to help solve problems with accurate insurance eligibility verification for their employees at healthcare provider locations and to help reduce fraud. The System is utilized help collect Health Risk Assessment Data and a biometric employee identification data (including but not limited to 3D facial recognition) on all of their employees and set up personal health records on the HIS. All covered employees receive a healthcare benefit card as their proof of insurance. Employers download and integrate the toolbar to their human resources management software were all of their employee benefits records are kept. The toolbar backs up all of the employee benefit records to the HIS. Once the employee benefit data is backed up, the toolbar tracks any changes in employee status and/or benefits and continuously updates the HIS. This information can be transmitted to healthcare providers on a real-time basis to accurately verify insurance eligibility on the patient at check-in.

Any stakeholder in the healthcare continuum including but not limited to employees, employers, patients, providers, insurance payers, pharmacies, labs, hospitals, clinics, clearinghouses, can download and get integrated with the toolbar and be interoperable with any other stakeholder integrated with the toolbar. Anyone who wishes to utilize the toolbar must go through a secure registration process required prior to downloading the toolbar from the HIS. Once the toolbar is downloaded all toolbar activity is a monitored, and recorded.

PMS and EMR software applications typically don't support biometric patient identification, nor do they store or communicate with biometric ID databases. The toolbar can be downloaded to any PMS or EMR software to enhance its functionality to support biometric patient identification.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A method of operating a healthcare information system using a user interface of a computer system connected to a healthcare information system via a network, said method comprising the steps of:
receiving member identification information from a user via the user interface;
sending the member identification information to the healthcare information system;
allowing one of the healthcare programs to be selected for the member via the user interface;
sending information on the selected healthcare program to the healthcare information system;
searching the healthcare information system to determine the member's eligibility for the selected healthcare program based on the member identification information; and
displaying information on the member's eligibility for the selected healthcare program via the user interface.

2. The method of claim 1, wherein the healthcare information system comprises a plurality of healthcare information networks exchanging healthcare information with each other.

3. The method of claim 1, wherein the network is the Internet.

4. The method of claim 1, wherein the user interface is a toolbar.

5. The method of claim 4, wherein the toolbar is integrated to a web browser.

6. The method of claim 1, further comprising the step of granting access to the health information system when the member identification information is valid.

7. The method of claim 6, wherein the step of receiving the user identification information comprises a step of capturing member biometric data from the user.

8. The method of claim 7, wherein the computer system comprises a biometric device configured to capture the member biometric data.

9. The method of claim 8, wherein the member biometric data is at least one of facial recognition data, fingerprint recognition data, voice recognition data, multi-dimensional signature recognition data and retina recognition data.

10. The method of claim 1, wherein the step of displaying healthcare information services comprises a step of displaying eligible healthcare programs for the member.

11. The method of claim 1, further comprising a step of sending an invoice for the selected healthcare program to the healthcare information system via the user interface.

12. The method of claim 11, wherein the invoice is sent to the member's healthcare provider via the healthcare information system.

13. The method of claim 11, further comprising steps of:
receiving payment information from the member's healthcare provider; and
displaying the payment information via the user interface.

14. The method of claim 6, further comprising steps of:
accessing a website provided by the healthcare information system;
downloading the user interface from the website;
installing the user interface to the computer system;
identifying the computer system;
identifying the user interface to identify the network;
registering the user interface, computer system and network to the healthcare information system.

15. The method of claim 14, further comprising steps of:
checking the user interface is installed in the computer system registered to the healthcare information system;
checking the user interface is connected to the network registered to the healthcare information system; and
disabling the user interface if the user interface is not installed in the registered computer system or connected to the registered network.
